(19) United States
(12) Patent Application Publication
(10) Pub. No.: US 2012/0142309 A1
(43) Pub. Date: Jun. 7, 2012

(54) INFORMATION COMMUNICATION SYSTEM, EMERGENCY USE DEVICE, AND PORTABLE COMMUNICATION DEVICE

(75) Inventors: Hiroki Oobayashi, Kanagawa (JP); Shinya Ema, Kanagawa (JP)

(73) Assignee: PANASONIC CORPORATION, Osaka (JP)

(21) Appl. No.: 13/390,672

(22) PCT Filed: Feb. 17, 2010
(86) PCT No.: PCT/JP2010/001003

§ 371 Date: Feb. 15, 2012

(30) Foreign Application Priority Data
Aug. 18, 2009 (JP) 2009-188877

(51) Int. Cl. H04W 4/22

(52) U.S. Cl. 455/404.1

(57) ABSTRACT

An information processing system includes an emergency use device and a portable communication device. The emergency use device includes an identification information storage section which stores identification information indicating a usage state and a transmitting section which transmits the identification information stored in the identification information storage section in response to a request from the portable communication device. The portable communication device includes a personal information storage section which stores personal emergency information, a communication section which communicates with the emergency use device, and a communication section which transmits the personal emergency information to a predetermined organization which is allowed to read the personal emergency information stored in the storage section when identification information indicating that the emergency use device is used is received from the emergency use device.

### TECHNICAL FIELD

The present invention relates to an information communication system which transmits personal emergency information to a predetermined organization on condition that an emergency use device is used.

### BACKGROUND ART

In recent years, it is increasing significantly that computers are utilized in therapy or diagnosis in the medical field. Especially in diagnosis, managing the personal information of patients by electronizing with electronic charts or the like has become widespread. Besides, emergency use devices, such as AEDs, have been installed in many pubic facilities, in recent years. In connection with this, it is increasing that average persons with little medical knowledge take medical measures at a public place.

Further, when an emergency which is related to a human fife occurs at a public place, in order to take measures promptly, it is necessary to immediately notify a specialist of emergency measures of medical information such as the patient's identity and blood group and make decision on the measures. However, an aiding person may be unable to obtain necessary information from the patient himself/herself due to such factors as the patient's condition or age.

A system for obtaining a patients personal information in an emergency is disclosed in the patent document 1 in which a person who possesses a privileged ID, such as an ambulance member, may acquire the patient's personal emergency information from the patient's mobile phone by sending the privileged ID and a password to a managing server.

With the above-mentioned system, the aiding person can obtain information required for the patient's medical measures, even when the required information cannot be obtained from the patient himself herself.

### RELATED ART DOCUMENTS

### Patent Documents

[Patent document 1]0 JP-A-2004-341738

### DISCLOSURE OF THE INVENTION

### Problems to be Solved by the Invention

However, according to a technique described in the patent document 1 only the limited persons who possess privileged IDs can obtain the information. Therefore, when the aiding person who is at tie patient's location does not have a privileged ID, required information could not be obtained until a person who possesses a privileged ID reaches the patient's location. Them is a problem that medical measures are overdue.

Further, when the mobile phone of the patient is locked for security reasons, since the person who possesses the privileged ID is not able to send the privileged ID and the password by operating the patient's mobile phone, required information for medical measures could not be obtained, and there is a problem that medical measures are overdue.

The present invention is made in order to solve the aforementioned problems. The purpose of the invention is to provide an information communication system, an emergency use device, and a portable communication device which can send personal emergency information to a predetermined organization on condition that the emergency use device is used.

### Means for Solving the Problems

An information communication system according to the invention, includes an emergency use device and a portable communication device, wherein the emergency use device includes an identification information storage section which stores identification information indicating a usage state and a transmitting section which transmits the identification information stored in the identification information storage section in response to a request from the portable communication device, and the portable communication device includes a personal information storage section which stores personal emergency information, a communication section which communicates with the emergency use device, and a communication section which transmits the personal emergency information to a predetermined organization which is allowed to read the personal emergency information stored in the personal information storage section when identification information indicating that the emergency use device is used is received from the emergency use device.

With the above configuration, the personal emergency information can be promptly transmitted to the predetermined organization without using a special ID.

Also, in the information communication system according to the invention, after the emergency use device is used for a period of time, identification information indicating a used state is stored.

With the above configuration, transmission of the identification information which indicates a usage state can be prevented when the emergency use device is not used.

Also, in the information communication system according to the invention, the emergency use device is changed to a communicable state in which the emergency use device is communicable with the portable communication device after the emergency use device is used for a period of time.

With the above configuration, communication with the portable communication device can be prevented when the emergency use device is not used.

Also, in the information communication system according to the invention, the portable communication device establishes communication with the emergency use device after both of the emergency use device communicable with the portable communication device and the portable communication device receive predetermined operations.

With the above configuration, communication can be established between the emergency use device and the portable communication device.

Also, in the information communication system according to the invention, when the emergency use device establishes communication with the portable communication device, the emergency use device transmits the identification information indicating that the emergency use device is used to the portable communication device.

With the above configuration, the identification information which indicates that the emergency use device is used can be transmitted from the emergency use device to the portable communication device.

Also, in the information communication system according to the invention, when the portable communication device receives the identification information indicating that the emergency use device is used, the portable communication device transmits the personal emergency information stored in the personal information storage section to a predetermined organization.

With the above configuration, the personal emergency information can be transmitted to the predetermined organization on condition that the emergency use device is used.

Also, in the information communication system according to the invention, when the portable communication device receives the identification information indicating that the emergency use device is used, the portable communication device transmits the personal emergency information stored in the personal information storage section to a predetermined organization.

With the above configuration, the personal emergency information can be stored by performing the predetermined operations.

### Advantageous Effects of the Invention

According to the information communication system of the invention, since a portable communication device transmits personal emergency information to a predetermined organization automatically when an emergency use device is used, the personal emergency information of an urgent person (a patient or the like) can be transmitted to the predetermined organization even without a special right and information required for taking medical measures can be provided promptly.

According to the information communication system of the invention, since personal emergency information is automatically transmitted to a predetermined organization on condition that an emergency use device is used, even if operations of a portable communication device are locked (invalid), the personal emergency information can be transmitted, while unnecessary transmitting of the personal emergency information can be prevented.

### BRIEF DESCRIPTION OF THE DRAWINGS

FIG. 1 is an entire configuration figure of an information communication system according to an embodiment of the invention.

FIG. 2 is a block diagram which shows a configuration of an emergency use device according to the embodiment of the invention.

FIG. 3 is a block diagram which shows a configuration of a portable communication device according to the embodiment of the invention.

FIG. 4 is a figure which shows a data configuration of personal emergency information stored in a storage section of the portable communication device according to the embodiment of the invention.

FIG. 5 is a flow chart explaining operations of the emergency use device according to the embodiment of the invention.

FIG. 6 is a flow chart explaining operations of the portable communication device according to the embodiment of the invention.

FIG. 7 is a figure which shows the processing sequence of the information communication system according to the embodiment of the invention.

### EMBODIMENTS OF THE INVENTION

Hereafter, an embodiment of the invention is described with reference to the figures.

### Embodiment 1

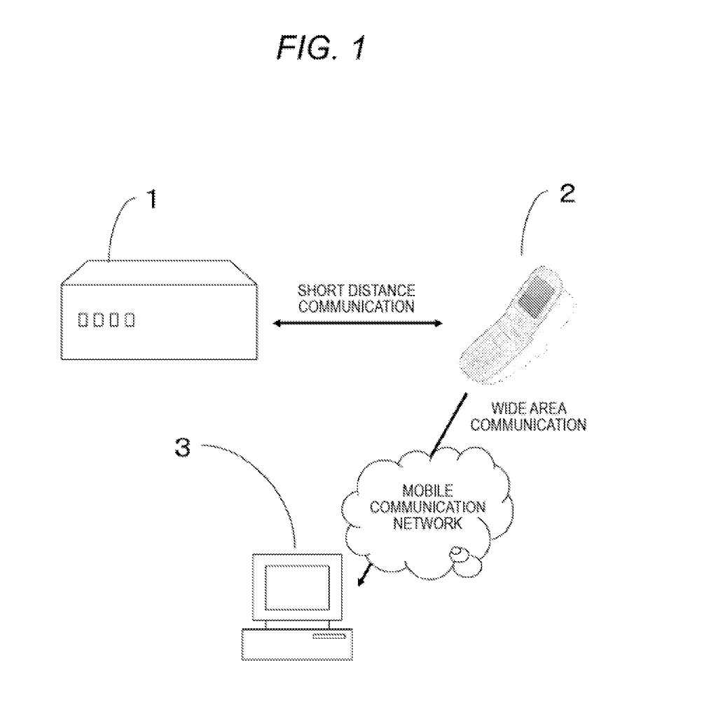

FIG. 1 is a figure which shows an entire configuration of an information communication system according to an embodiment of the invention. The information communication system according to the embodiment of the invention includes an emergency use device 1, a portable communication device 2, and a personal information receiving terminal 3, as shown in FIG. 1.

The emergency use device 1 is a device which is used when an emergency related to a human life occurs to take emergency measures, and is assumed as, for example, an AED (Automated External Defibrillator).

The portable communication device 2 is a wireless communication terminal which can he carried, and is assumed as, for example, a mobile phone.

The emergency use device 1 performs short distance communication with the portable communication device 2, and transmits to the portable communication device 2 usage information which indicates whether the emergency use device 1 is used.

After the portable communication device 2 receives the usage information from the emergency use device 1, the portable communication device 2 performs wide area communication via a mobile communication network, and transmits personal emergency information to the personal information receiving terminal 3 which is installed in a predetermined organization (for example, a hospital, a fire department, etc.).

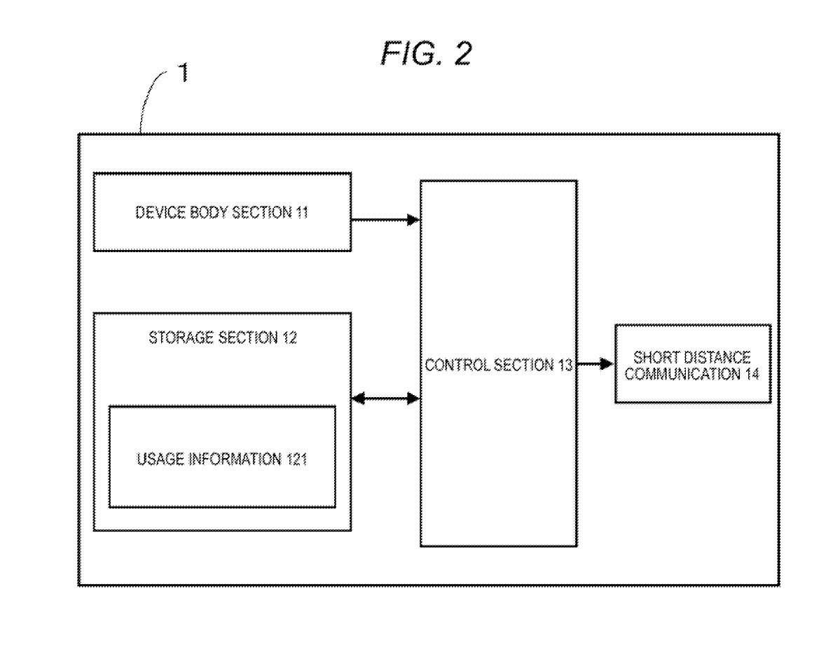

FIG. 2 is a block diagram which shows a configuration of the emergency use device 1 according to the embodiment of the invention.

As shown in the figure, the emergency use device 1 according to the embodiment of the invention includes a device body section 11, a storage section 12, a control section is, and a short distance communication section 14.

The device body section 11 is a part which is used for emergency measures of the device. For example, it raters to a discharging device for the ASP, When an emergency measure is taken, the device body section 11 notifies the control section 13 of usage information 121 which shows that the emergency measure is taken.

The storage section 12 stores the usage information 121 of the device body section 11. An initial value of the usage information 121, for example, “0” which indicates an unused state is stored, and when the usage information 121 is notified by the control section 13, the usage information 121 is updated to, for example, “1” which indicates a used state.

The control section 13 controls the whole processes of the emergency use device 1. In particular, the control section 13 receives the usage information 121 output from the device body section 11, The control section 13 transmits the usage information 121 to the storage section 12. The control section 13 makes controls necessary for the short distance communication section 14 to perform communication.

The short distance communication section 14 transmits the usage information 121 output from the control section 13 to the portable communication device 2, for example, with non-contact ICs, such as Felica (registered trademark), Bluetooth (registered trademark), or infrared rays.

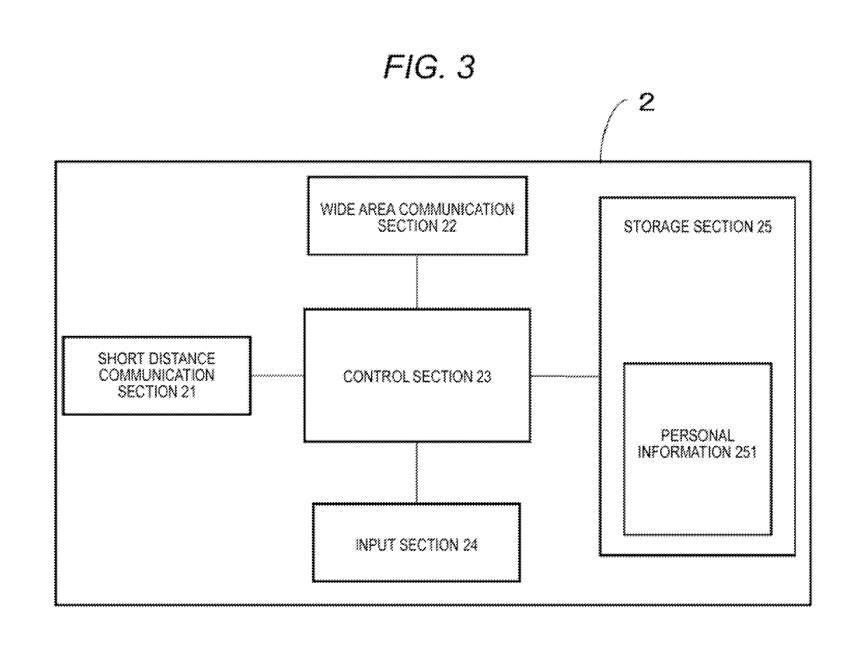

FIG. 3 is a block diagram which shows a configuration of the portable communication device 2 according to the embodiment of the invention.

As shown in the figure, the portable communication device 2 according to the embodiment of the invention includes a short distance communication section 21, a wide area communication section 22, a control section 23, an input section 24, and a storage section 25.

The short distance communication section 21 receives the usage information 121 transmitted from the emergency use device 1, for example with non-contact ICs, such as Felica (registered trademark), Bluetooth (registered trademark), or infrared rays.

The wide area communication section 22 transmits a personal emergency information 401 which combines the usage information 121 and a personal information 251 to the personal information receiving terminal 3. The details of the personal emergency information 401 are described later.

The control section 23 controls the whole processes of the portable communication device 2. In particular, the control section 23 receives the usage information 121 output from the short distance communication section 21. The control section 23 receives the personal information 251 input from the input section 24, The control section 23 transmits the personal information 251 input from the input section 24 to the storage section 25, The control section 23 transmits to the wide area communication section 22 the personal emergency information 401 which combines the usage information 121 output from the short distance communication section 21 and the personal information 251 stored in the storage section 25.

The input section 24 includes devices such as buttons or a touch panel and receives the personal information 251 input by a user's operation.

The storage section 25 stores the personal information 251 of the owner of the portable communication device 2, The details of the personal information 251 are described later.

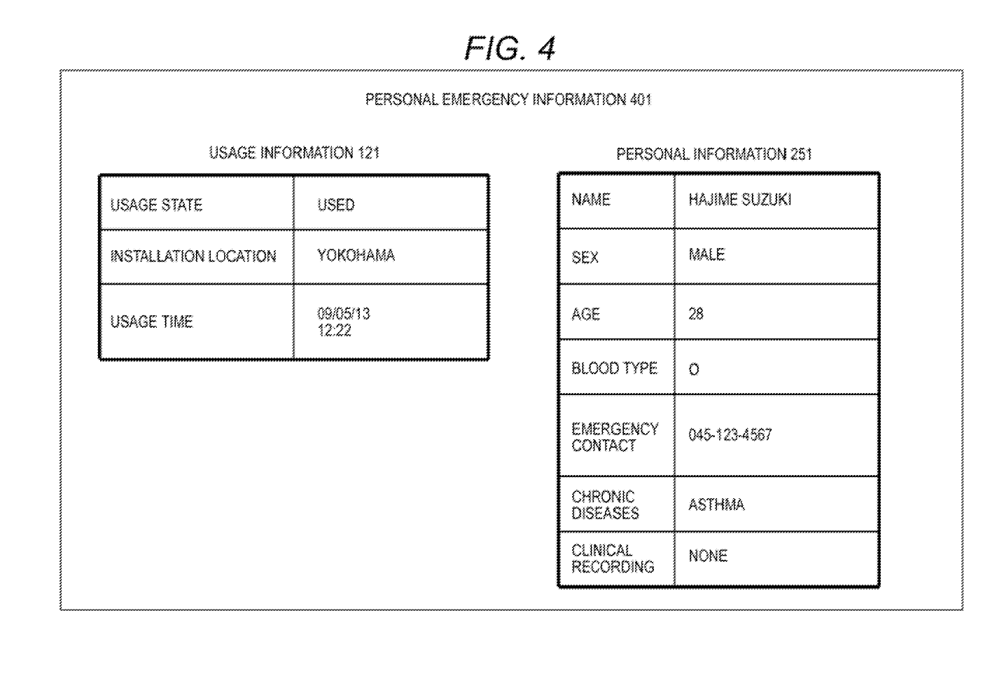

FIG. 4 shows a data configuration of the personal emergency information 401 transmitted to the personal information receiving terminal 3 according to the embodiment of the invention.

The personal emergency information 401 includes the personal information 251 and the usage information 121.

The usage information 121 shows a usage state, an installation location and a usage time of the device body section 11. The usage information 121 is up-dated according to the usage conditions of the device body section 11, and is notified to the portable communication device 2 via the short distance communication section 14.

The personal information 251 shows those information required for medical measures in emergency, such as the name, the sex, the age, the blood type, the emergency contact, the chronic diseases, and the clinical recording of the owner of the portable communication device 2.

The personal information 251 should be beforehand registered into the storage section 25 by the user via the input section 24.

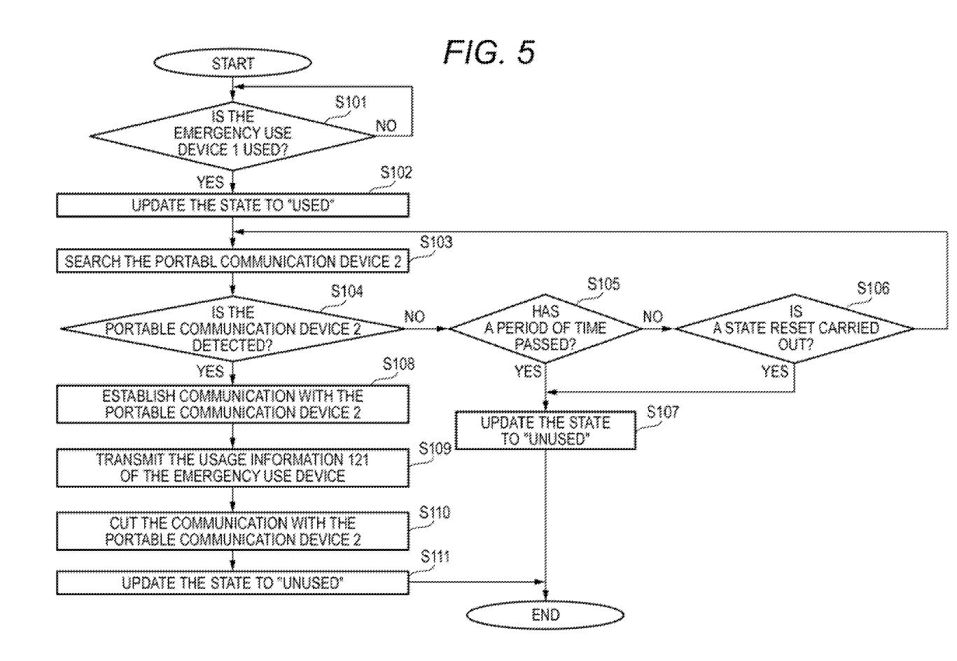

FIG. 5 is a flow chart which explains operations of the emergency use device 1 according to the embodiment of the invention.

First the control section 13 judges whether the information which indicates a used state is received from the device body section 11 (Step S101).

Here, the control section 13 repeats the process of Step S101 again, when the information which indicates a used state is not received from the device body section 11 (Step S101, No).

On the other hand, when the control section 13 receives the information which indicates a used state from the device body section 11 (Step S101, Yes), the usage information 121 of the storage section 12 is updated to “1” which indicates a used state (Step S102), Next, the control section 13 searches for the portable communication device 2 that can communicate with the short distance communication section 14 (Step S103).

Here, when the short distance communication section 14 receives and detects ACK from the portable communication device 2 which can communicate (Step S104, Yes), the short distance communication section 14 of the emergency use device 1 establishes communication with the short distance communication section 21 of the portable communication device 2 (Step S108), Next, the control section 13 reads out the usage information 121 from the storage section 12, and transmits the usage information 121 to the portable communication device 2 via the short distance communication section 14 (Step S109). Next, the short distance communication section 14 cuts communication with the short distance communication section 21 of the portable communication device 2 (Step S110). Next, the control section 13 updates the usage information 121 of the storage section 12 to “0” which indicates an unused state (Step S111).

On the other hand, when the short distance communication section 14 is not able to detect the portable communication device 2 which can communicate (Step S104, No), the control section 13 judges whether a period of time has passed since the information which indicates a used state was received from the device body section 11 (Step S105).

Here, when the control section 13 judges that a period of time has passed since the information which indicates a used state was received from the device body section 11 (Step S105, Yes), the control section 13 updates the usage information 121 of the storage section 12 to “0” which indicates an unused state (Step S107), and the processes are finished.

On the other hand, when the control section 13 judges that a period of time has not passed since the information which indicates a used state was received from the device body section 11 (Step S105, No), the control section 13 judges whether a state reset was carried out in the device body section 11 (Step S106). A state reset refers to a process of returning the preset value used in the emergency use device 1 to an initial state.

Here, when the control section 13 Judges that a state reset process is carried out (Step S106, Yes), the control section 13 updates the usage information 121 of the storage section 12 to “0” which indicates an unused state (Step S107), and the processes are finished.

On the other hand, when the control section 13 judges that a state reset process was not carried out (Step S106, No), the control section 13 searches for the portable communication device 2 which can communicate again (Step S103).

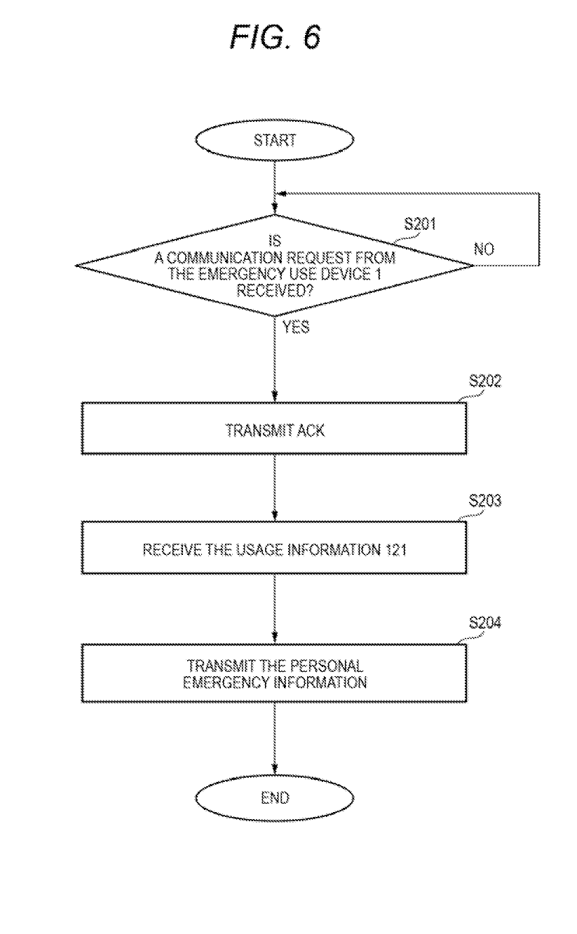

FIG. 6 is a flow chart which explains operations of the portable communication device 2 according to the embodiment of the invention.

First, the control section 23 judges whether the short distance communication section 21 of the portable communication device 2 receives a communication request from the short distance communication section 14 of the emergency use device 1 (Step S201).

Here, when it is judged that the short distance communication section 21 does not receive a communication request from the short distance communication section 14 of the emergency use device 1 (Step S201, No), the control section 23 repeats the process of Step S201 again.

On the other hand, when it is judged that the short distance communication section 21 receives a communication request from the short distance communication section 14 of the emergency use device 1 (Step S201, Yes), the control section 23 makes ACK to be transmitted by the short distance communication section 21, and communication is established (Step S202).

Next, after the communication is established, the short distance communication section 21 of the portable communication device 2 receives the usage information 121 from the short distance communication section 14 of the emergency use device 1 (Step S203).

Next after the usage information 121 is received,, the control section 23 reads out the personal information 251 from the storage section 25 and transmits the personal information 251 to the personal information receiving terminal 3 via the wide area communication section 22 together with the usage information 121 (Step S204), and the processes are finished.

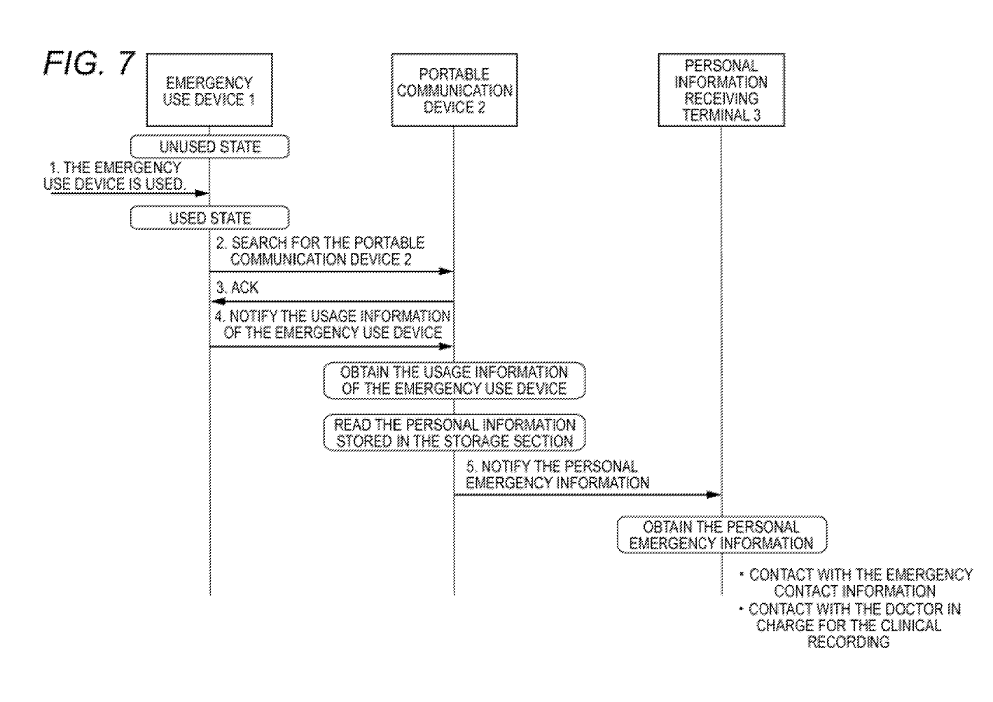

FIG. 7 is a figure which shows the processing sequence of the information communication system according to the embodiment of the invention.

First, when an emergency such as a sudden ventricular fibrillation, or consciousness losing after a traffic accident is encountered occurs, when an aiding person takes emergency measures using the emergency use device 1, the control section 13 updates the usage information 121 of the storage section 12 to “1” which indicates a used state.

Next, the short distance communication section 14 of the emergency use device 1 searches for the portable communication device 2 which can communicate.

Next, after the communication is established, the short distance communication section 14 of the emergency use device 1 transmits the usage information 121 to the short distance communication section 21 of the portable communication device 2.

Next, after the short distance communication section 21 of the portable communication device 2 receives the usage information 121 the control section 23 automatically transmits the personal emergency information 401 which combines the personal information 251 stored in the storage section 25 and the received usage information 121 to the personal information receiving terminal 3.

As mentioned above, according to the information communication system of an embodiment of the invention, unnecessary time-consuming information transmitting can be inhibited by transmitting the personal information 251 on condition that the emergency use device 1 is used.

The personal information 251 can be prevented from being revealed to a third party, such as an aiding person, by being automatically transmitted to the personal information receiving terminal 3 from the portable communication device 2.

The personal emergency information 401 received by the personal information receiving terminal 3 is utilized to take suitable medical measures, such as contacting with a doctor in charge.

Although the present invention is described in detail with reference to specific embodiments, it is apparent that various modifications and amendments may be made by those skilled in the art without departing from the spirit and scope of the invention.

This application is based on the Japanese patent application (patent application 2009-188877) filed on Aug. 15, 2009, the contents of which are incorporated herein by reference.

### INDUSTRIAL APPLICABILITY

The invention is an information communication system which includes an emergency use device and a portable communication device. When the owner of the portable communication device which has a security lock encounters an emergency, and the release of the security lock cannot he performed spontaneously, the personal emergency information registered beforehand is automatically transmitted to an emergency contact on condition that the emergency use device is used. Thus, the invention has effects that the personal information would not be unnecessarily exposed to a third party, and preparation for performing quick treatments can be made. Therefore, the invention can be applied to portable communication devices, such as mobile phones, PDAs, or notebook computers.

### DESCRIPTION OF REFERENCE NUMERALS AND SIGNS

1 emergency use device
2 portable communication device
3 personal information receiving terminal
11 device body section
12 storage section
13 control section
14 short distance communication section
121 usage information
21 short distance communication section
22 wide area communication section
23 control section
24 input section
25 storage section
251 personal information
401 personal emergency information

1. An information communication system, comprising:
an emergency device; and
a portable communication device,
wherein the emergency device includes:
an identification information storage section which stores identification information indicating a usage state; and
a transmitting section which transmits the identification information stored in the identification information storage section in response to a request from the portable communication device; and
wherein the portable communication device includes:
a personal information storage section which stores personal emergency information;
a communication section which communicates with the emergency device; and
a communication section which transmits the personal emergency information to a predetermined organization which is allowed to read the personal emergency information stored in the personal information storage section when identification information indicating that the emergency device is used is received from the emergency device.

2. The information communication system according to claim 1, wherein after the emergency device is used for a period of time, identification information indicating a used state is stored.

3. The information communication system according to claim 1, wherein the emergency device is changed to a communicable state in which the emergency device is communicable with the portable communication device after the emergency device is used for a period of time.

4. The information communication system according to claim 1, wherein the portable communication device establishes communication with the emergency device after both of the emergency device communicable with the portable communication device and the portable communication device receive predetermined operations.

5. The information communication system according to claim 1, wherein when the emergency device establishes communication with the portable communication device, the emergency device transmits the identification information indicating that the emergency device is used to the portable communication device.

6. The information communication system according to claim 1, wherein when the portable communication device receives the identification information indicating that the emergency device is used, the portable communication device transmits the personal emergency information stored in the personal information storage section to a predetermined organization.

7. The information communication system according to claim 1, wherein the portable communication device can store the personal emergency information in the personal information storage section by performing a predetermined operation.

8. An emergency device used in the information communication system according to claim 1.

9. A portable communication device used in the information communication system according to claim 1.
